(19) United States
(12) Patent Application Publication
(10) Pub. No.: US 2026/0048943 A1
(43) Pub. Date: Feb. 19, 2026

(54) CURVED BELT CONVEYOR

(71) Applicant: AVANCON SA, Riazzino (CH)

(72) Inventor: Dieter SPECHT, Arcegno (CH)

(21) Appl. No.: 19/120,499

(22) PCT Filed: Oct. 14, 2022
(86) PCT No.: PCT/EP2022/078716

§ 371 Date: Apr. 11, 2025

(51) Int. Cl. B65G 15/02; B65G 23/06

(52) U.S. Cl. CPC B65G 15/02; B65G 23/06

(57) ABSTRACT

A curved belt conveyor comprising an inner profile that extends along a segment of a circle with an inner radius and an angle, an outer profile (2) that extends along a segment of a circle with an outer radius (Ro) and the same angle, an endless belt (3) that is mounted on two end conveyor rollers that are arranged between the inner profile and the outer profile, at least one curved guide (5) with two slots (53) facing the outer profile (2) is arranged on the outer profile (2) between the two end conveyor rollers, and cleats (6) with a lug (61) facing the inner profile are arranged on an inner belt surface (30) in the region of an outer belt edge (31), wherein at least some of the cleats (6) located between the two end conveyor rollers are guided with their lug (61) in the corresponding slot (53) of the curved guide (5).

### TECHNICAL FIELD OF THE INVENTION

The current invention relates to conveyors, in particular to curved sections of belt conveyors.

### DESCRIPTION OF THE RELATED ART

With curved belt conveyors, a belt is arranged on rollers that are not parallel to one another, but that are arranged at an angle to one another. Due to this design, the resulting force from the rollers acting on the belt, points towards the inside of the belt curve. If the belt is allowed to move towards the inside of the belt curve, the tension on the belt is reduced, which leads to a slacking of the belt and a reduction of the static friction between the belt and the rollers.

EP 1 879 815 discloses a known embodiment of such a curved belt conveyor. In it, there are cleats that are arranged on an inner surface of the belt in the region of an outer belt edge and guiding rolls that are arranged on a segment of a circle. The guiding rolls exert a force on the cleats from the inside of the belt curve, whereby the belt is forced towards the outside of the belt curve.

Such a design is complicated and costly to manufacture, to assemble and to maintain.

### SUMMARY OF THE INVENTION

It is a task of current invention to provide a curved belt conveyor that is easy and reasonably to manufacture, to assemble and to maintain.

This task is solved by a curved belt conveyor with the features of claim 1. Further embodiments of the curved belt conveyor are defined by the features of further claims.

A curved belt conveyor according to the invention comprises an inner profile that extends along a segment of a circle with an inner radius and an angle, an outer profile that extends along a segment of a circle with an outer radius and the same angle, an endless belt that is mounted on two end conveyor rollers that are arranged between the inner profile and the outer profile in both of their end regions. At least one curved guide with two slots facing the outer profile is arranged on the outer profile between the two end conveyor rollers. Cleats with a lug facing the inner profile are arranged on an inner belt surface in the region of an outer belt edge, wherein at least some of the cleats located between the two end conveyor rollers are guided with their lug in the corresponding slot of the curved guide.

With such a design, the interaction of the cleats with the curved guide resulting in the endless belt being pulled towards the outer profile, which prevents the endless belt from moving towards the inner profile and additionally tensions the endless belt between the two end conveyor rollers. Such a curved belt conveyor is easy to assemble and maintain.

In the above-described, the inner radius in relation with the inner profile corresponds to the inner profile of the endless belt and is located on the side of the inner profile, facing the outer profile and the outer radius in relation with the outer profile corresponds to the outer profile of the endless belt and is located on the side of the outer profile, facing the inner profile.

It is possible to arrange two or more curved guides between the two end conveyor rollers that are aligned with each other, wherein neighbouring curved guides can touch each other, or they can be spaced apart from one another.

For additionally supporting the endless belt, it is possible to arrange at least one intermediate conveyor roller between the two end conveyor rollers. On its outer side, the at least one intermediate conveyor roller can be arranged on the curved guide or can be arranged on the outer profile, between two neighbouring curved profiles. On its inner side, the at least one intermediate conveyor roller can be arranged on the inner profile. There can be two or more intermediate conveyor rollers that are arranged equally spaced between the two end conveyor rollers. The intermediate conveyor rollers can have the same diameter than the end conveyor rollers or their diameter can be smaller. If the diameter is smaller, the intermediate conveyor rollers are arranged as such that they touch the inner belt surface on their upper side.

In one embodiment, the curved guide comprises a curved base band whose radius of curvature corresponds to the outer radius, two limbs that extend perpendicularly from the base band towards the centre of curvature, and two flaps which are each arranged on a free end of the two limbs on a side of the limb opposite the other limb. The flaps extend away from the centre of curvature, resulting in the two slots that are each formed between the corresponding limb and the corresponding flap.

In one embodiment, a maximal distance between the outside surfaces of the two flaps of the curved guide corresponds to the diameter of a roller of the end conveyor rollers with a roller radius.

In one embodiment, a maximal distance between the inside surfaces of the two limbs of the curved guide corresponds to the diameter of a pulley of the conveyor roller with a pulley radius.

In one embodiment, the two limbs and the two flaps are formed integrally in a single piece with the base band. Alternatively, they can be assembled from individual components.

In one embodiment each cleat comprises a base body and is arranged on the inner belt surface with a base body outer surface. The lug extends laterally from the base body, wherein a cleat inner surface is identical for the base body and the lug, and wherein the base body outer surface is offset to a lug outer surface.

In one embodiment, an extension extends laterally from the base body, parallel and offset to the lug, whereby a trench is formed between the lug and the extension and wherein the base body outer surface is identical for the base body and the extension.

In one embodiment, the maximal distance between the two flaps corresponds to the roller diameter minus two times the thickness of the extension of the cleats.

In one embodiment, at least a part of the base body outer surface is curved, and its radius of curvature corresponds to the roller radius of the roller of the end conveyor roller, and/or wherein at least a part of the cleat inner surface is curved, and its radius of curvature corresponds to the pulley radius of the pulley of the end conveyor roller.

In one embodiment, the lug is formed integrally in a single piece with the base body. Alternatively, the lug can be fixed to the base body.

In one embodiment, the extension is formed integrally in a single piece with the base body. Alternatively, the extension can be fixed to the base body.

In one embodiment, at least one hole extends through the base body and/or wherein at least one hole extends through the extension and wherein each cleat is fixed to the belt by means of at least one fixation element that is arranged in the at least one hole. The at least one hole can be a through borehole, and the fixation element is a rivet, such as a hollow rivet or a fixation bush, such as a clamping bush. Alternatively, the at least one hole is a threaded hole, and the fixation element is a screw.

In one embodiment, the end conveyor roller comprises a roller and a pulley, wherein the pulley is arranged on the side of the roller facing the outer profile. The inner belt surface is in contact with the roller and the cleat inner surface is in contact with the pulley.

In one embodiment, the roller and the pulley are mounted on a common shaft. The roller and the pulley can be fixed to one another, or they can be fixed to the shaft. In both cases a relative movement between the roller and the pulley is prevented.

In one embodiment, the curved guide comprises a flap end face on a side of each flap facing the outer profile, wherein said flap end faces are in contact with some of the cleats. Alternatively, the cleats comprise a lug end face on a side of the lug facing the inner profile, wherein the lug end faces of some of the cleats are in contact with the curved guide.

In one embodiment, the pulley comprises a skin surface that is in contact with the cleat inner surface of some of the cleats. The cleats comprise a lug end face on a side of the lug facing the inner profile and wherein the pulley comprises a collar that extends radially outwards from the skin surface around its entire circumference and that is in contact with some of the lug end faces.

The features of the above-mentioned embodiments of the curved belt conveyor can be used in any combination, unless they contradict each other.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a perspective view of a curved belt conveyor according to the invention;

FIG. 2 a perspective view of the end conveyor rollers and curved guide of FIG. 1;

FIG. 3 a partial sectional view through the belt and the curved guide of FIG. 1;

FIG. 4 a perspective view of one end region of the curved guide of FIG. 1;

FIG. 5 a partial sectional view through the belt and one end conveyor roller of FIG. 1;

FIG. 6 a front face view of one end conveyor roller, the belt and the curved guide of FIG. 1;

FIG. 7 a perspective view of a first embodiment of a cleat according to the invention;

FIG. 8 a partial perspective view of the belt with cleats of FIG. 1;

FIG. 9 a perspective view of a second embodiment of a cleat according to the invention;

FIG. 10 a partial sectional view through the belt with cleats of FIG. 9 and through a second embodiment of the curved guide; and

FIG. 11 a partial sectional view through the belt and the curved guide with cleats with longer lugs.

### DETAILED DESCRIPTION OF THE INVENTION

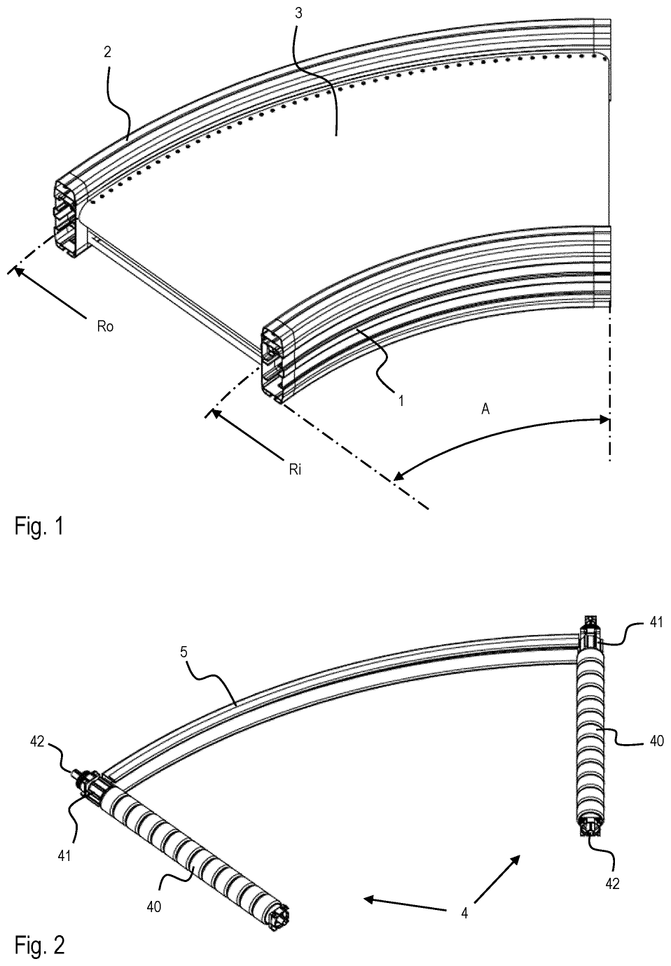

FIG. 1 shows a perspective view of a curved belt conveyor according to the invention. It comprises an inner profile 1 that extends along a segment of a circle with an inner radius Ri and an angle A, an outer profile 2 that extends along a segment of a circle with an outer radius Ro and the same angle A, and an endless belt 3.

FIG. 2 shows a perspective view of the end conveyor rollers 4 and a curved guide of FIG. 1. The endless belt 3 is mounted on two end conveyor rollers 4 that are arranged between the inner profile 1 and the outer profile 2 in both end regions of these profiles. The curved guide 5 is arranged between the two end conveyor rollers 4. Each of the two end conveyor rollers 4 comprise a roller 40 and a pulley 41 that are arranged on a common shaft 42.

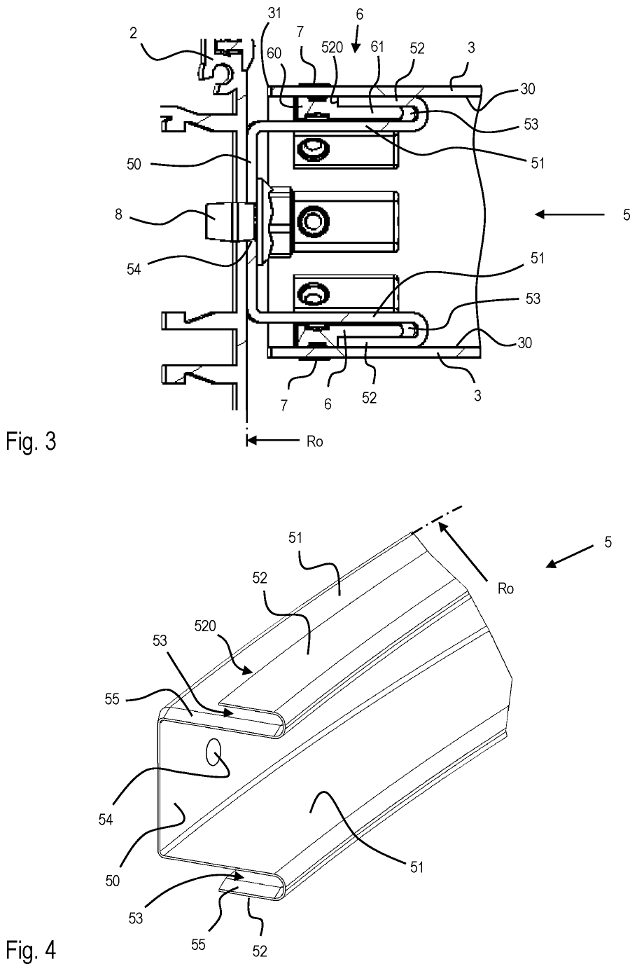

FIG. 3 shows a partial sectional view through the belt 3 and the curved guide 5 of FIG. 1 and FIG. 4 shows a perspective view of one end region of the curved guide of FIG. 1. The curved guide 5 comprises a curved base band 50, whose radius of curvature corresponds to the outer radius Ro. Two limbs 51 extend perpendicularly from the upper and lower end of the base band 50 towards the centre of curvature, i.e., towards the inner profile. A flap 52 is arranged on the free end of each of the two limbs 51. The flaps are created by folding back each limb on the outside of the curved guide 5, resulting in a flap 51 on a side of one limb 51 opposite the other limb 51, wherein the flaps 52 extend away from the centre of curvature, parallel to the limbs 51. There is a flap end face 520 on the free end of each of the two flaps 52. A slot 53 is formed between a corresponding limb 51 and a corresponding flap 52. Bevels 55 are provided in the end regions of the curved guide 5, on the edges thereof which are directed towards the slots 53. A hole 54 is arranged in the base band 50 of the curved guide 5, in which a fixation screw 8 can be arranged for fixing the curved guide 5 to the outer profile 2. Cleats 6 are arranged on the inner belt surface 30 and are fixed to it in the region of an outer belt edge 31 by means of fixation bushes 7. The cleats 6 are spaced from the outer belt edge 31 but can also be flush with it. A lug 61 of the cleat 6 extends parallel to the inner belt surface 30, away from the outer profile 2 and protrudes in the slot 53 of the curved guide 5. The flap end face 520 of the curved guide 5 abuts the base body 60 of the cleat 6, on the side opposite to the outer profile 2.

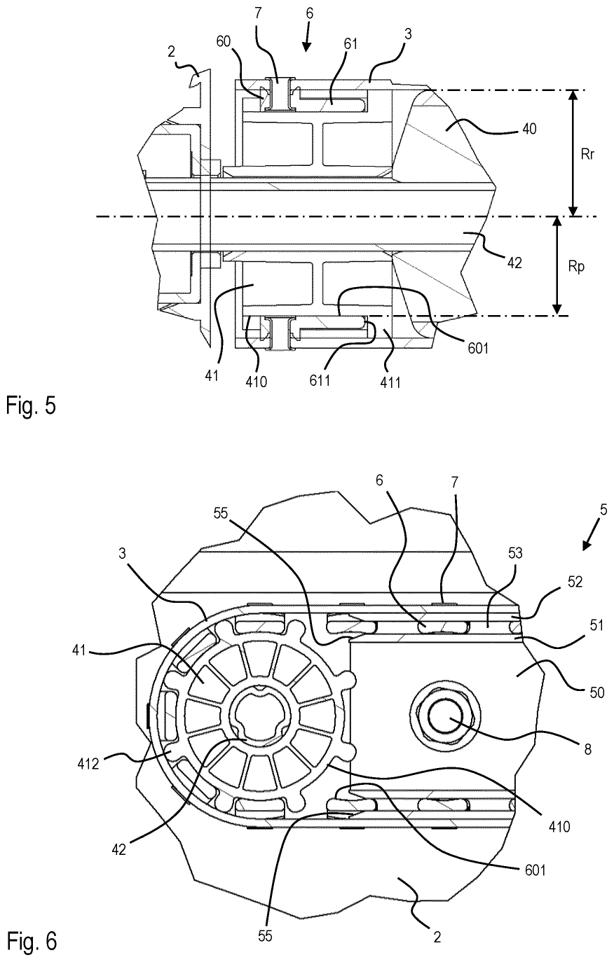

FIG. 5 shows a partial sectional view through the belt 3 and one end conveyor roller 4 of FIG. 1. The end conveyor roller 4 comprises a roller 40 and a pulley 41 that are fixed to a common shaft 42. The shaft 42 is a hollow profile that is rotatably mounted to the outer profile 2 and the inner profile 1 (not shown). The pulley 41 has a skin surface 410 with a pulley radius Rp which is in contact with the cleat inner surface 601 during the deflection of the cleats 6. On the side of the pulley opposite to the outer profile 2 a collar 411 is provided, extending radially outwards from the skin surface 410 around its entire circumference and wherein the radius of the collar skin surface corresponds to the roller radius Rr. The lug end face 611 of the cleat 6 abuts a lateral surface of the collar 411.

FIG. 6 shows a front face view of one end conveyor roller 4, the belt 3 and the curved guide 5 of FIG. 1. Pulley 41 has cams 412 that extend radially outward from the skin surface 410 and that are equally spaced around its circumference. The distance between two neighbouring cams 412 corresponds to the width of a cleat 6. The rotation of the shaft 42 is transmitted to the belt 3 by the cleats 6 and the cams 412. During operation, i.e., when the curved belt conveyor is running, after leaving a recess between two neighbouring cams 412 or before entering it, the cleats 6 are guided in the slots 53 of the curved guide 5, between its limbs 51 and its flaps 52. The bevels 55 on the edges of the curved guide 5 facing the pulley 41 help to align the cleats 6 with the slots 53.

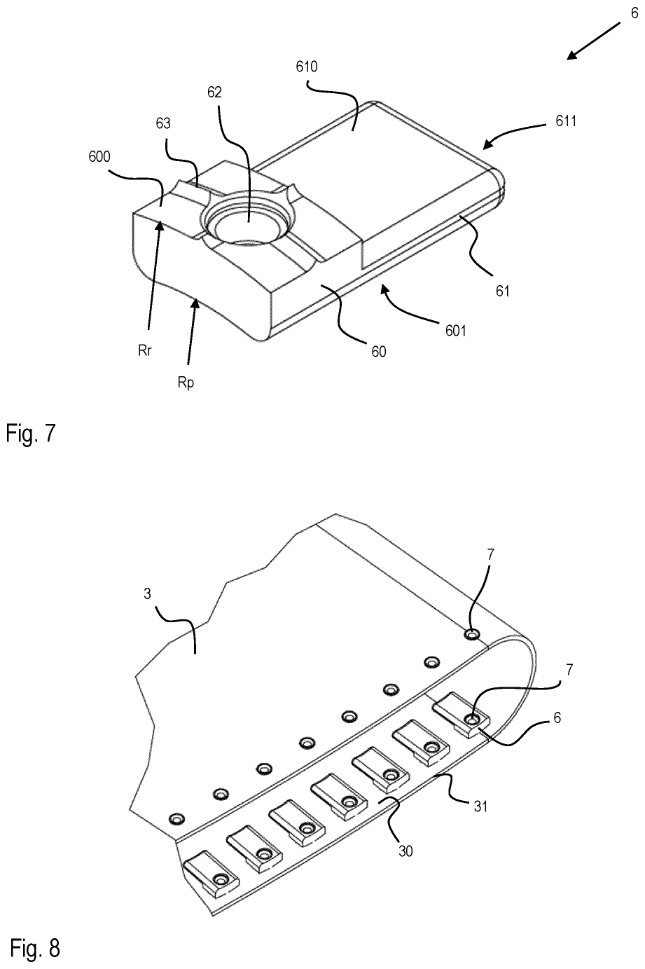

FIG. 7 shows a perspective view of a first embodiment of a cleat 6 according to the invention. It comprises a base body 60 with a base body outer surface 600 and a lug 61 that extends laterally from the base body 60, wherein a cleat inner surface 601 is identical for the base body 60 and the lug 61. The base body outer surface 600 is offset to a lug outer surface 610. A hole 62 extends through the base body 60 from the base body outer surface 600 to the cleat inner surface 601. The majority base body outer surface 600 is curved and its radius of curvature corresponds to the roller radius Rr. There are ridges 63 that extend from the outer body surface 600. They are oriented in the direction of the extension of the lug 61 and perpendicular thereto. The ridges 63 prevent the cleats 6 from rotating when mounted to the endless belt 3. The cleat inner surface 601 is entirely curved, and its radius of curvature corresponds to the pulley radius Rp. The edges of the lug 61 are rounded.

FIG. 8 shows a partial perspective view of the endless belt 3 with cleats 6 of FIG. 1. The cleats are arranged on the inner belt surface 30 spaced from the outer belt edge 31 and equally spaced around the corresponding circumference. The distance from the cleat 6 to the outer belt edge 31 corresponds to the thickness of the cleat 6. Each cleat 6 is fixed to the endless belt 3 by fixation bushes 7.

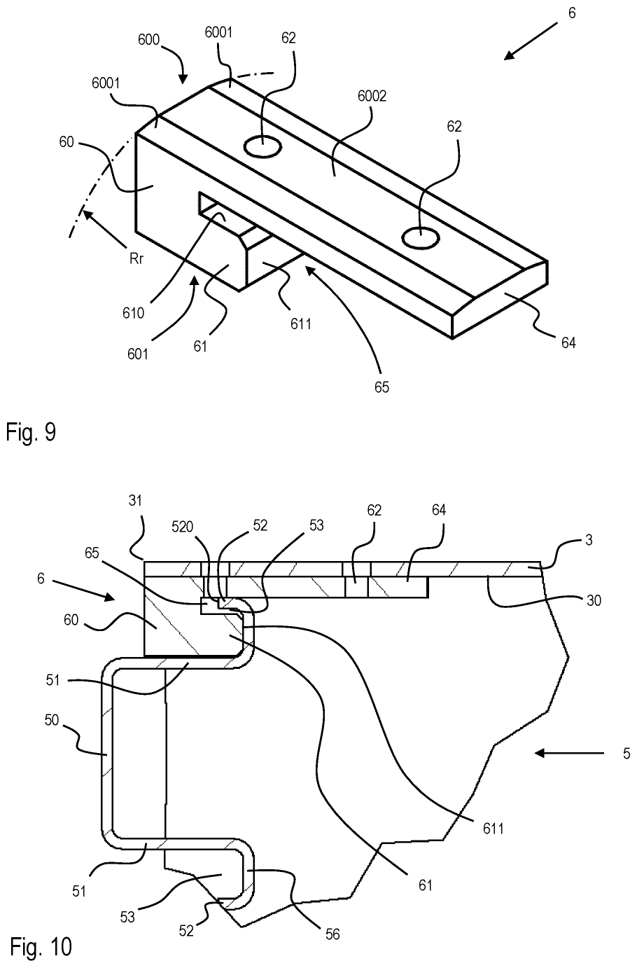

FIG. 9 shows a perspective view of a second embodiment of a cleat 6 according to the invention. Like the first embodiment, the second embodiment comprises a base body 60 with a base body outer surface 600 and a lug 61 with a common cleat inner surface 601 with the base body 60. In contrast to the first embodiment, the second embodiment has no hole extending through the base body and there are no ridges extending from the base body outer surface. In addition to the features of the first embodiment, the second embodiment comprises an extension 64 that extends laterally from the base body 60, parallel and offset to the lug 61, resulting in a trench 65 between the lug 61 and the extension 64. The base body outer surface 600 is identical for the base body 60 and the extension 64. Two holes 62 are provided in the extension 64 next to the base body 60, wherein one hole is arranged in the region of the lug 61 and the other is arranged in the region of the free end of the extension 64. The middle section of the base body outer surface 600 that comprises the holes and is straight. The two lateral sections 6001 of the base body outer surface 600 are curved and their radius of curvature corresponds to the roller radius Rr.

FIG. 10 shows a partial sectional view through the endless belt 3 with cleats of FIG. 9 and through a second embodiment of the curved guide 5. The cleats 6 are arranged on the inner belt surface 30 by means of fixation elements (not shown) that are arranged in the holes 62 and in corresponding holes of the endless belt. The base body 60 of the cleats 6 is flush with the outer belt edge 31. The second embodiment of the curved guide 5 comprises a base band 50, two limbs 51 that are connected to the free ends of the base band 50 that extend perpendicular to the base band 50. A straight section 56 is connected to each of the free ends of the limbs 51 that extends parallel to the base band 50 in a direction opposite to the other straight section 56. A flap 52 is connected to each of the free ends of the straight sections 56 that extends perpendicular to the base band towards the base band 50. The slots 53 of the curved guide 5 are defined by a part of the outer surface of the limbs 51 and the surface of the straight section 56 facing the base band 50 and the surface of the flaps 52 facing the other flap. The lug 61 of the cleat 6 projects into the slot 53 of the curved guide 5 and the flap 52 of the curved guide 5 projects into the trench 65 of the cleats 6. The lug end face 611 of the cleats 6 abuts the straight section 56 of the curved guide 5 and the flap end face 520 of the curved guide 5 is spaced from the base body 60 of the cleats 6. The

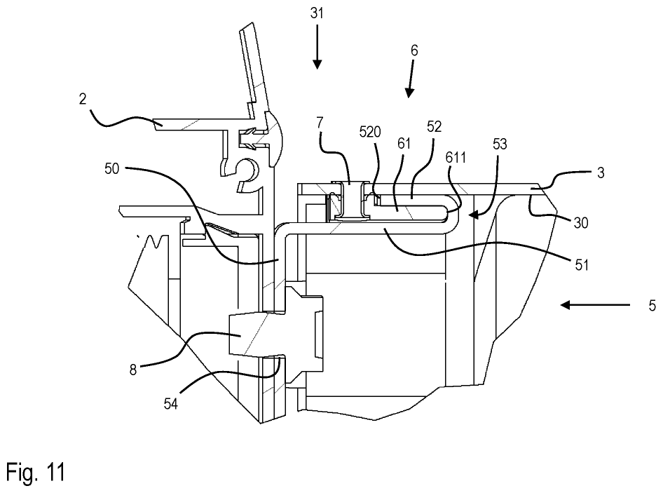

FIG. 11 shows a partial sectional view through the endless belt 3 and the curved guide 5 with cleats 6 with longer lugs 61. The lug end face 611 of the cleats 6 abuts the rounded section between the limbs 51 and the corresponding flaps 52 of the curved guide 5 and the flap end face 520 of the curved guide 5 is spaced from the base body 60 of the cleats 6.

REFERENCE SIGNS LIST

| | | | |
|---|---|---|---|
| 1 | inner profile | 60 | base body |
| 2 | outer profile | 600 | base body outer |
| 3 | belt | | surface |
| 30 | inner belt surface | 6001 | lateral section |
| 31 | outer belt edge | 601 | cleat inner surface |
| 4 | end conveyor roller | 61 | lug |
| 40 | roller | 610 | lug outer surface |
| 41 | pulley | 611 | lug end face |
| 410 | skin surface | 62 | hole |
| 411 | collar | 63 | ridge |
| 412 | cam | 64 | extension |
| 42 | shaft | 65 | trench |
| 5 | curved guide | 7 | fixation bush |
| 50 | base band | 8 | fixation screw |
| 51 | limb | | |
| 52 | flap | A | angle |
| 520 | flap end face | Ri | inner radius |
| 53 | slot | Ro | outer radius |
| 54 | hole | Rr | roller radius |
| 55 | bevel | Rp | pulley radius |
| 56 | straight section | | |
| 6 | cleat | | |

1. A curved belt conveyor comprising an inner profile (1) that extends along a segment of a circle with an inner radius (Ri) and an angle (A), an outer profile (2) that extends along a segment of a circle with an outer radius (Ro) and the same angle (A), an endless belt (3) that is mounted on two end conveyor rollers (4) that are arranged between the inner profile (1) and the outer profile (2) in both of their end regions, at least one curved guide (5) with two slots (53) facing the outer profile (2) is arranged on the outer profile (2) between the two end conveyor rollers (4), and cleats (6) with a lug (61) facing the inner profile (1) are arranged on an inner belt surface (30) in the region of an outer belt edge (31), wherein at least some of the cleats (6) located between the two end conveyor rollers (4) are guided with their lug (61) in the corresponding slot (53) of the curved guide (5).

2. The curved belt conveyor according to claim 1, wherein the curved guide (5) comprises a curved base band (50) whose radius of curvature corresponds to the outer radius (Ro), two limbs (51) that extend perpendicularly from the base band (50) towards the centre of curvature, and two flaps (52) which are each arranged on a free end of the two limbs (51) on a side of the limb (51) opposite the other limb (51), wherein the flaps (52) extend away from the centre of curvature, and wherein the two slots (53) are each formed between the corresponding limb (51) and the corresponding flap (52).

3. The curved belt conveyor according to claim 2, wherein a maximal distance between the outside surfaces of the two flaps (52) of the curved guide (5) corresponds to the diameter of a roller (40) of the end conveyor roller (4) with a roller radius (Rr).

4. The curved belt conveyor according to claim 2, wherein a maximal distance between the inside surfaces of the two limbs (51) of the curved guide (5) corresponds to the diameter of a pulley (41) of the end conveyor roller (4) with a pulley radius (Rp).

5. The curved belt conveyor according to claim 2, wherein the two limbs (51) and the two flaps (52) are formed integrally in a single piece with the base band (50).

6. The curved belt conveyor according to claim 1, wherein each cleat (6) comprises a base body (60) and is arranged on the inner belt surface (30) with a base body outer surface (600), wherein the lug (61) extends laterally from the base body (60), wherein a cleat inner surface (601) is identical for the base body (60) and the lug (61), and wherein the base body outer surface (600) is offset to a lug outer surface (610).

7. The curved belt conveyor according to claim 6, wherein an extension (64) extends laterally from the base body (60), parallel and offset to the lug (61), whereby a trench (65) is formed between the lug (61) and the extension (64) and wherein the base body outer surface (600) is identical for the base body (60) and the extension (64).

8. The curved belt conveyor according to claim 7, wherein the maximal distance between the two flaps (52) of the curved guide (5) corresponds to the roller diameter (Rr) minus two times the thickness of the extension (64) of the cleats (6).

9. The curved belt conveyor according to claim 6, wherein at least a part of the base body outer surface (600) is curved and its radius of curvature corresponds to the roller radius (Rr) of the roller (40) of the end conveyor roller (4), and/or wherein at least a part of the cleat inner surface (601) is curved and its radius of curvature corresponds to the pulley radius (Rp) of the pulley (41) of the end conveyor roller (4).

10. The curved belt conveyor according to claim 6, wherein the lug (61) is formed integrally in a single piece with the base body (60).

11. The curved belt conveyor according to claim 7, wherein the extension (64) is formed integrally in a single piece with the base body (60).

12. The curved belt conveyor according to claim 6, wherein at least one hole (62) extends through the base body (60) and/or wherein at least one hole (62) extends through the extension (64) and wherein each cleat (6) is fixed to the belt (3) by means of at least one fixation element (7) that is arranged in the at least one hole (62).

13. The curved belt conveyor according to claim 6, wherein the end conveyor roller (4) comprises a roller (40) and a pulley (41) that is arranged on the side of the roller (40) facing the outer profile (2), wherein the inner belt surface (30) is in contact with the roller (40) and wherein the cleat inner surface (601) is in contact with the pulley (41).

14. The curved belt conveyor according to claim 6, wherein the roller (40) and the pulley (41) are mounted on a common shaft (42).

15. The curved belt conveyor according to claim 2, wherein the curved guide (5) comprises flap end faces (520) on a side of the flap (52) facing the outer profile (2), which flap end faces (520) are in contact with some of the cleats (6), or wherein the cleats (6) comprise a lug end face (611) on a side of the lug (61) facing the inner profile (1), wherein the lug end faces (611) of some of the cleats (6) are in contact with the curved guide (5).

16. The curved belt conveyor according to claim 4, wherein the pulley (41) comprises a skin surface (410) that is in contact with the cleat inner surface (601) of some of the cleats (6), wherein the cleats (6) comprise a lug end face (611) on a side of the lug (61) facing the inner profile (1) and wherein the pulley (41) comprises a collar (411) that extends outwards from the skin surface (410) and that is in contact with some of the lug end faces (611).
